(19) United States
(12) Patent Application Publication
(10) Pub. No.: US 2021/0122062 A1
(43) Pub. Date: Apr. 29, 2021

(54) Glass Decking System, Adaptable End Effector and Methods

(71) Applicant: Comau LLC, Southfield, MI (US)

(72) Inventors: Vellbor Kllibarda, Southfield, MI (US); Freddie Tappo, Sterling Heights, MI (US); William Frazer, Wixom, MI (US); Richard Pietila, Howell, MI (US)

(21) Appl. No.: 17/079,463

(22) Filed: Oct. 24, 2020

Related U.S. Application Data
(60) Provisional application No. 62/926,524, filed on Oct. 27, 2019.

(51) Int. Cl. B25J 15/00; B60J 1/00

(52) U.S. Cl. CPC B25J 15/0019; B60J 1/00

(57) ABSTRACT

A glass decking system and an adaptable end effector useful for engaging and installing glass panels and other components having varying panel geometries in a high volume product assembly line. The end effectors include integrated engaging blocks having a locating element and a holding element which allow the end effector to engage and install glass panels having varying geometries without having to change or physically reconfigure the end effectors. The glass decking system and adaptable end effectors are useful for installing glass panels of varying geometries on predetermined different areas of the vehicle, for example windshields, backlites and quarter glass, without having to change or reconfigure the robot end effectors.

### CROSS-REFERENCE TO RELATED APPLICATIONS

This application claims priority benefit to U.S. Provisional Patent Application No. 62/926,524 filed Oct. 27, 2019 the entire contents of which is incorporated herein by reference.

### TECHNICAL FIELD

The present invention generally pertains to the automated assembly of products. One example application is the installation of glass panels in a progressively-assembled motor vehicle.

### BACKGROUND

High volume assembly of products and vehicles typically employs automated assembly processes. In assembling large products, often industrial, multi-axis programmable robots are used to pick up, manipulate and position large components, for example glass panels or sheet components, along an assembly line. These processes are also commonly carried out when assembling small devices as well.

In such automated assembly processes, conventional robots are positioned along various positions or assembly stations along an assembly line. Each robot is typically assigned and programmed to grasp a component or components and perform an assembly operation. An example robotic assembly operation may be grasping a glass panel component from a shipping rack, moving the glass panel toward an installation position on a vehicle, and releasing and installing the glass panel in the vehicle panel opening, for example the windshield opening of the vehicle.

Each conventional assembly robot typically must include a tool or device commonly known as an end effector to grasp or otherwise engage a component. A conventional end effector is a tool that connects to a robot wrist and receives power and actuating instructions from the robot processor and controller for controlling the timing and movement of the end effector according to the work the robot end effector is designed to accomplish. Conventional robotic assembly processes typically required a custom made or dedicated end effector for each robot according to the specific geometry of the component the robot was designed to grasp and manipulate. In a large assembly facility, this typically requires dozens, if not hundreds, of different end effectors which is very costly and time consuming to fabricate, install and maintain.

Additionally, if the assembly line alternates the type or model of products to be assembled, this often required shut down of the line to change or reconfigure many of the robot end effectors to accommodate the differently configured panel for that different model, for example a different windshield with different dimensions and/or panel contour. Alternately, complex and expensive tool changer devices must be used which disengage and set down one end effector and pick up another to accommodate the model assembly change. This changing of end effectors, or reconfiguring the end effectors, slows production cycle times and reliability of the device and assembly line. Conventional end effectors have been advantageous in high-volume “batch build” type systems where high volumes of the same product are produced. These conventional end effectors are disadvantageous in “random build” type assembly lines and facilities where several different versions or models of products are frequently interchanged to coincide with orders to meet customer demand.

Conventional glass panel installation or “decking” systems use end effectors that have either a modular frame or a manufactured frame that is specific for a particular glass panel and are not configurable or adaptable for use with differently configured glass panels. Typical glass decking systems also use grippers that require individual units such as risers, blades, and arms, for each functional component to be engaged by the gripper. Accordingly, typical glass decking robot end effectors are highly complex, large and bulky, prone to collisions, are time consuming to configure and reconfigure, and expensive to construct.

Conventional glass decking end effectors typically use separate, dedicated devices for positionally locating the glass panel and holding or securing the glass panel. For example, bumpers or blocks are used for locating the glass panel relative to the end effector and vacuum suction cups are used for engaging and holding the glass panel. The use of these separate, dedicated units create staggered opposing vector forces that can adversely influence or change the shape of the glass to be installed and ultimately compromise the geometry and fit of the glass panel to the vehicle body.

### BRIEF SUMMARY

The present invention includes a glass decking system and an adaptable robot end effector useful in the glass decking system, or in other systems. The exemplary adaptable end effector is operable to accommodate or adapt to a variety of differently configured panels, for example glass panels, having different glass panel geometries or contours. The glass decking system including robots and adaptable end effectors is operable to install a variety of differently configured glass panels in a plurality of different locations on the vehicle. The adaptability to engage different glass panels and install them on different locations of the vehicle, is accomplished without having to stop operation of the decking system to change or reconfigure the end effectors due to the differently configured glass panels.

In one example, the adaptable end effector includes a base plate, a plurality of integrated blocks used to engage the glass panel, and an actuator operable to move selected of the engaging blocks to engage the particular glass panel to be engaged and installed. Each of integrated blocks includes a holding element to engage the glass panel, and a locating element which contacts the engaged panel securing the glass panel in place to the end effector. In one example, the locating elements each include an abutment surface which receives the glass panel when engaged and secured by the end effector. In one example, the locating element abutment surfaces are numerical control and/or precision machined surfaces (NC surfaces) to be the same as, or corresponding to, the as-designed surface or contour of the glass panel engaged by that particular integrated block.

In one example, a particular end effector is equipped with at least one first integrated block connected to and positioned on the base plate operable to contact a first glass panel when the holding elements engage the first glass panel. The particular end effector may also equipped with at least one second integrated block connected to and positioned on the base plate operable to contact a second glass panel having a different second contour or configuration when the holding elements engage the second glass panel. The particular end effector may also include at least one combination integrated block connected to and positioned on the base plate. The combination integrated block is operable to contact the first glass panel when the holding elements engage a first glass panel or alternately operable to contact the second glass panel when the holding elements engage a second glass panel.

In one example, the adaptable end effector includes a sensor connected to the base plate to detect one or more predetermined metrics of the glass panel and/or vehicle. In one example, the sensor captures an image of the glass panel when the end effector is about to grasp and verify that the present end effector operating parameters are appropriate for the particular imaged glass panel. The sensor may also detect other metrics at different points in the process, for example, validating that the end effector has physically engaged or disengaged a glass panel.

One example of the glass decking system includes at least a first glass decking station positioned on opposing sides of the assembly line and vehicle path of travel. In one example a first and a second decking station is included on both sided of the assembly line.

In one example of a decking station, a programmable robot including an adaptable end effector is used to engage and install a variety of differently configured glass panels and install the engaged glass panels in different locations on the vehicle without having to change or reconfigure the end effectors as described above.

One example of the glass decking station includes a panel transfer area where the panels are selectively positioned prior to engagement by the robot for installation. In another example a monitoring area is used to detect one or more metrics of the glass panel prior to engagement and installation on the vehicle. In another example, the robots are selectively movable on tracks to position the robots relative to the vehicle depending on the engaged glass panel to be installed on the vehicle.

In one example the glass decking system includes a primary glass decking cell and a back-up glass decking cell. One or both of the primary and/or decking cells include the at least one decking station described above.

Other features and functions understood by those skilled in the art will be apparent after reviewing the following technical descriptions and drawings.

### BRIEF DESCRIPTION OF THE DRAWINGS

The description herein makes reference to the accompanying drawings wherein like reference numerals refer to like parts throughout the several views, and wherein:

FIG. 1 is a schematic diagram of one example of a glass decking system including a primary and backup glass cell.

FIG. 2A is a top perspective view of an example of an adaptable end effector.

FIG. 2B is front view of the example adaptable end effector shown in FIG. 2A.

FIG. 2C is a bottom perspective view of the example adaptable end effector shown in FIG. 2A engaged with an exemplary glass panel.

FIG. 3A is perspective view of one example of an integrated block shown in FIG. 2C.

FIG. 3B is a cross-sectional view of the integrated block taken along line B-B in FIG. 3A.

FIG. 4A is partial cross-sectional view of an alternate integrated block with the holding element positioned in a first position.

FIG. 4B is partial cross-sectional view of the alternate integrated block in FIG. 4A with the holding element positioned in a second position.

FIG. 5A is an enlarged partial cross-sectional view of an alternately configured integrated block showing the holding element moving from a first position to a second position.

FIG. 5B is an enlarged partial cross-sectional view of the integrated block in FIG. 5A in the second position.

FIG. 6 is a top perspective view of an example of the adaptable end effector in use to alternately engage two differently configured glass panels.

FIG. 6A is a top view of the adaptable end effector in FIG. 6.

FIG. 6B is a front view of the FIG. 6.

FIG. 6C is a schematic partial front view of the adaptable end effector of FIG. 6B.

FIG. 6D is a partial cross-sectional view of an example of a combination integrated block engaged with the larger glass panel shown in FIG. 6

FIG. 6E is a partial cross-sectional view of the combination integrated block in FIG. 6D engaged with the smaller glass panel shown in FIG. 6.

FIG. 7 is a schematic of an example of a control system useful with the glass decking system and/or adaptable end effector.

### DETAILED DESCRIPTION

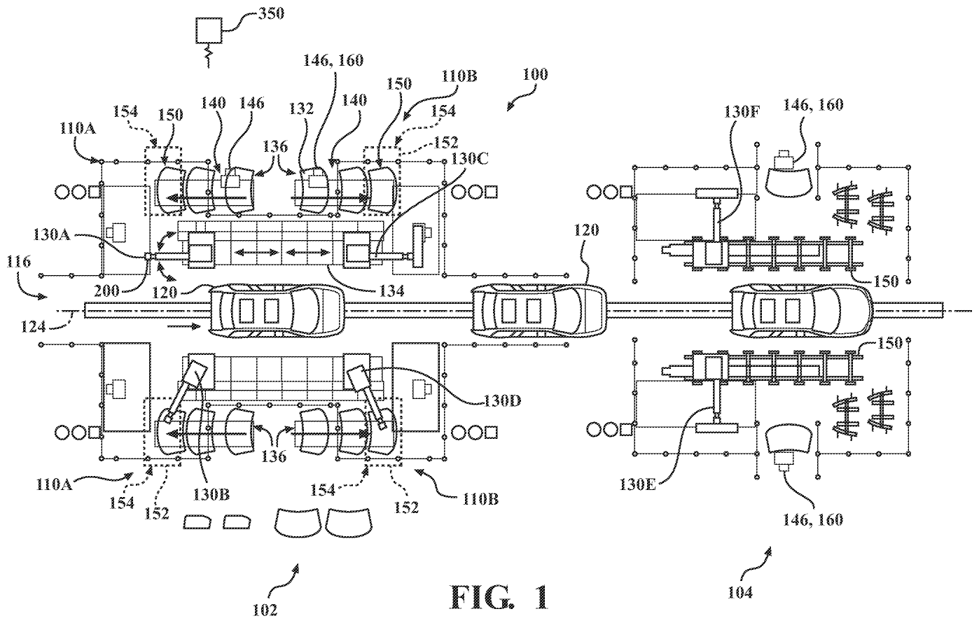

Referring to FIGS. 1-7, examples of a glass decking system 100 and an adaptable end effector 200 useful in the glass decking system 100 are shown. The decking system 100 and end effector 200 are particularly, but not exclusively, useful for installing or “decking” passenger vehicle glass panels in vehicles in high volume vehicle assembly facilities. The glass decking system 100 and end effector 200 have other applications and uses where, for example, large panels need to be engaged, manipulated, and/or positioned or installed in a predetermined place with a high degree of accuracy and precision. The disclosed inventions have other applications known by those skilled in the art. The system 100 and adaptable end effector 200 are each useful for components other than alternately contoured panels, for example small or alternately configured parts and components.

### Glass Decking System

Referring to FIG. 1 an example of a glass decking system 100 is shown. The exemplary glass decking system 100 is a modular system that is useful in a variety of vehicle assembly plants and operable to serve one or more, and preferably at least two, different product or vehicle models, for example a first vehicle model and a second vehicle model requiring different glass panels than the first vehicle model. System 100 is useful in applications other than installing glass panels in passenger vehicles as known by those skilled in the art.

As shown in the FIG. 1 example, the glass decking system 100 includes a primary glass decking cell 102 and a back-up glass decking cell 104 where vehicles 120 sequentially move along a path of travel 124 through the primary 102 and back-up 104 cells. In the example, the primary cell 102 includes at least a first decking station 110A positioned on each side of a vehicle path of travel 124 as generally shown. In the FIG. 1 example, each of the first decking stations includes a second decking station 110B positioned downstream of the first decking stations 110A (four total decking stations shown).

In the example FIG. 1 primary cell 102, each decking station 110A, 110B (collectively 110 unless identified individually) includes one or more programmable, multi-axis robots 130 (one shown per station 110) for use in engaging, manipulating, and installing, for example, vehicle glass panels 132 (four robots 130A-D shown, collectively 130 unless identified individually). In the exemplary stations 110, one or more of the robots 130 are operable to selectively travel on tracks 134 mounted to the facility floor adjacent to the path of travel 124 as generally shown. The track 134 allows the supported robots 130 to selectively travel along the track 134 to and from predetermined positions to, for example, engage a glass panel 132 to be installed and/or position the robot 130 relative to the vehicle 120 to install an engaged and supported glass panel 132 in the predetermined position on the vehicle 120.

In the example using moveable robots 130 on tracks 134, robots 130 may be positioned on powered carts with actuators, for example electric motors, that are in communication with control system 130 wherein the actuators are energized and de-energized to automatically move the robots 130 between predetermined positions. Other devices and methods for moving robots 130 known by those skilled in the art may be used. It is also understood that one or more of the robots 130 may be used without track 134. In this example, the one or more robots may be stationarily mounted to the facility floor or other structure. It is further understood that one or more robots 130 may be mounted to elevated or overhead positioned support structures and suspend downward versus mounted to tracks 134 or stationarily mounted to the facility floor.

In the FIG. 1 example, each robot 130 includes an adaptable end effector 200 (end effector) described further below to install predetermined glass panels 132 in predetermined positions on the vehicle 120. For example in the FIG. 1, each robot 130 and associated end effector 200 may be preconfigured and preprogrammed to install glass panels 132 in the form of windshields, quarter glass, sunroof glass, glass roof panels, backlights, or any combination thereof, for multiple vehicle sedans, hatchbacks, coupes, sport utility vehicles (SUVs) trucks, and different models of those vehicles, without the need to reconfigure or change the end effectors 200. For example, robot 130A may be configured and operable to install a backlight and/or left quarter glass, robot 130B may be operable to install the backlight and/or right quarter glass, robot 110C may be operable to install a windshield and/or glass roof panel, and/or robot 110D may be operable to install a windshield and/or glass roof panel.

It is understood that the robots 130 may be configured and programmed to install alternate glass panels 132, or other panels or objects, to a vehicle 120, or other product, to suit the particular application. It is further understood that a greater or fewer number of decking station 110, and/or robots 130, may be used to suit the particular application and performance requirements. Alternately, or in addition to, robots 130, other automated devices and/or programmable devices may be used with end effector 200 to engage, manipulate, and install glass panels 132, other panels, or other components, as known by those skilled in the art to suit the particular application.

Exemplary decking stations 110 further each include a panel transition area 136 operable to sequence or buffer several glass panels prior to engagement by robot 130. In one example, each panel transition area 136 includes a conveyor 140 positioned within reach or communication of the station 110 robot 130. Exemplary conveyor 140 includes an entry end 146 and an exit end 150 positioned at the opposite end of the conveyor 140. In one example, conveyor 140 is an endless belt-type conveyor which supports and transfers glass panels 132 which are placed and positioned on the conveyor 140 at the entry end 146 and are selectively moved toward the exit end 150 where the station robot 130 engages the glass panel 132 for installation on vehicle 120 as further described below. It is understood that different forms of conveyors 140 may be used to suit the particular application. It is understood that other devices, for example automated guided vehicles (AGVs), may be used instead of the conveyor 140 as described to move the panels from the entry end 146 to the exit end 150.

Still referring to the example primary cell 102 and panel transition area 136, in one example, individual glass panels 132 are sequentially loaded or positioned onto conveyor 140 at the entry end 146. This may be conducted using an automated device, for example a programmable robot (not shown), manually by an operator, or semi-automated through a load assist device (not shown). In one example, the conveyor 140 automatically indexes toward exit end 150 as glass panels are removed by station robot 130 from the exit end 150 for installation on the vehicle. Movement or indexing by the conveyor 140 may be made through sensors (not shown), for example in the monitor area 154 described below, in communication with the control system 350. Other devices and methods to index the glass panels 132 toward the exit end 150 known by those skilled in the art may be used. The conveyor 140 may have fixtures or other tooling positioned thereon which receive and accurately and precisely position the glass panels 132 relative to the conveyor, robot 130, and/or the vehicle 120 so the robot can properly engage the glass panel 132 in the exit end 150 for installation.

In an alternate example of station 110 and panel transition area 136, a conveyor 140 is not used. In the example, the station robot 130 may directly engage a glass panel positioned in, for example, a predetermined position glass dunnage rack or other holding fixture (not shown). In the example, robot 130 would engage the next positioned glass panel 132 from the rack or fixture and either install it on the vehicle 120 as previously described, or move the engaged glass panel to an intermediate process step, for example into exit end 150 for further processing before installation. This alternate process may be used, for example if conveyor 140 malfunctions or is undergoing maintenance or other service.

In an alternate example, panel transition area 136 can alternately be used as a place for inspection of the glass panel 132, application of adhesive to the glass and inspection thereof, and/or other processes, prior to engagement by station robot 130 for installation on the vehicle 120. In the example of use as an inspection area, if a glass panel does not pass a quality inspection, for example missing or misapplied adhesive, the rejected glass panel 132 can be removed from the station 110 by an operator or other automated device.

In the FIG. 1 example, when the glass panel 132 is positioned in the exit end 150 of the conveyor 140, the respective robot 130 will move to place end effector 200 (described further below) into engagement with the glass panel 132 for installation of the engaged glass panel 132 to the vehicle 120.

As shown in the FIG. 1 example, the glass decking system 100 includes one or more monitoring areas 152 positioned in, or in communication with, the decking station 110 exit area 150. The monitoring areas 152 may be configured with sensors, imaging devices, and/or other scanning devices (collectively sensors) 154 which are operable to monitor or check incoming glass panels 132 for one or more quality metrics. For example, sensors 154 may scan or image glass panels, or other panels or components, for predetermined quality control checks and/or metrics such as panel type or identification, for example a glass panel for a particular vehicle model being assembled or positioned in the primary cell 102. Other glass panel metrics may include, for example, glass panel dimensions, size, shape, contour, tint and other aspects.

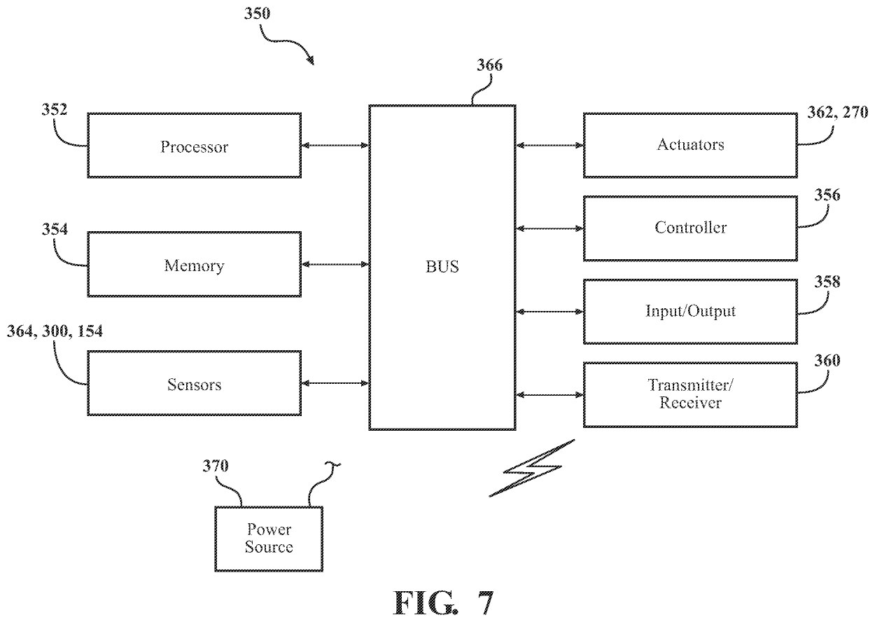

The exemplary sensors 154 may include one or more of high resolution cameras, including but not limited to video cameras, laser scanning devices, ultrasonic or frequency devices, or other devices, that are in hardwire or wireless communication with a local or central control system 350 whereby data is stored on each glass panel 132, for example the different glass panels to be installed in primary cell 102. The control system may further store in a data memory storage device in control system 350 (FIG. 7), assembly build or process data, for example the vehicle build schedule including data on the specific vehicles and the sequential order the vehicles or other products are to be assembled.

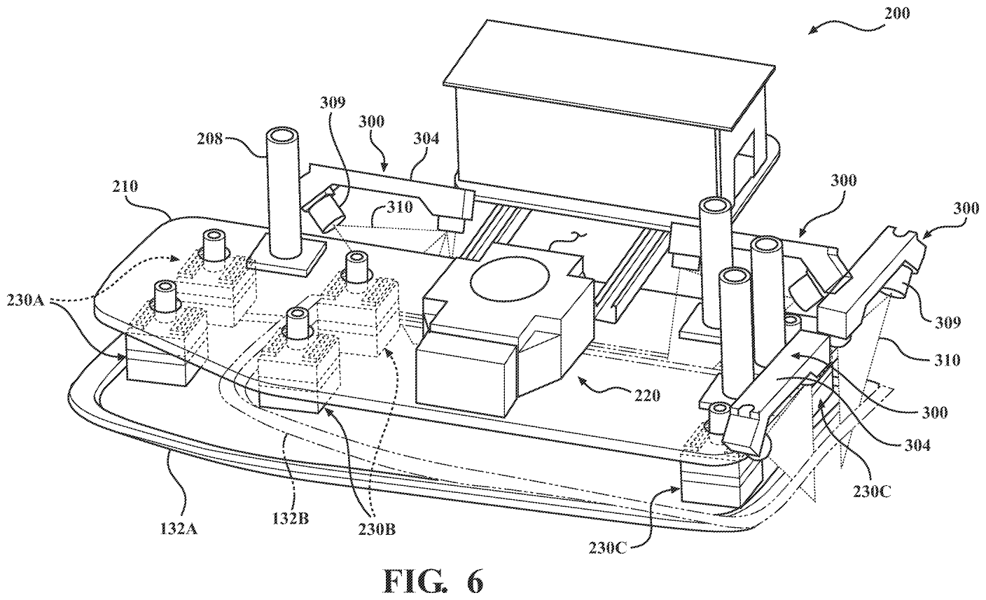

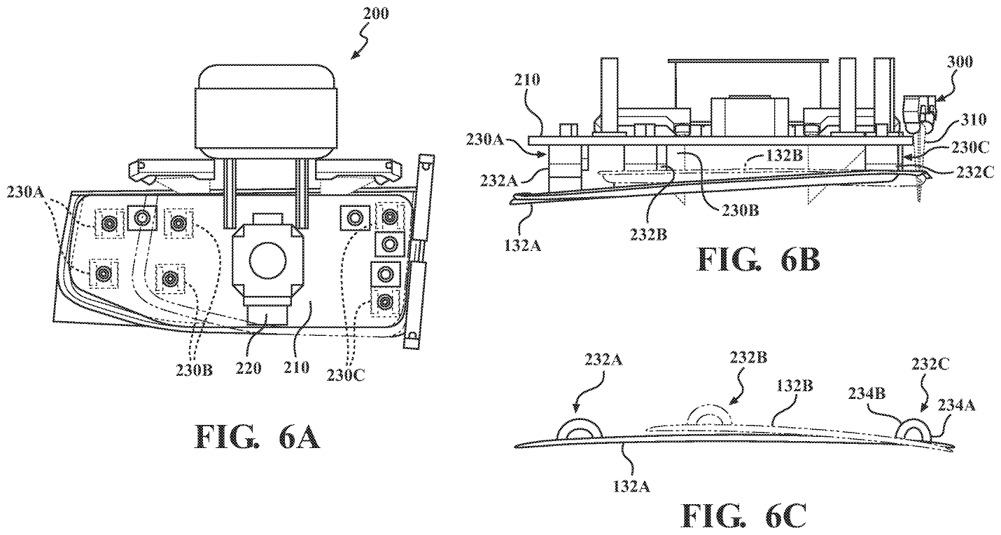

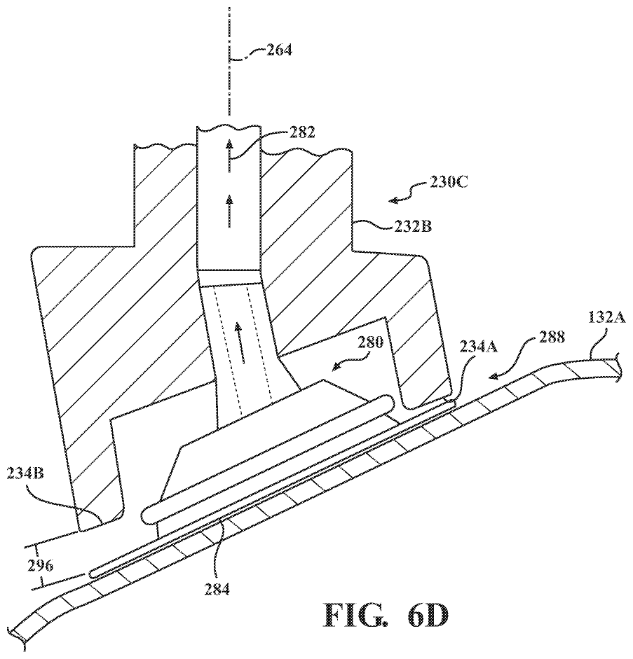

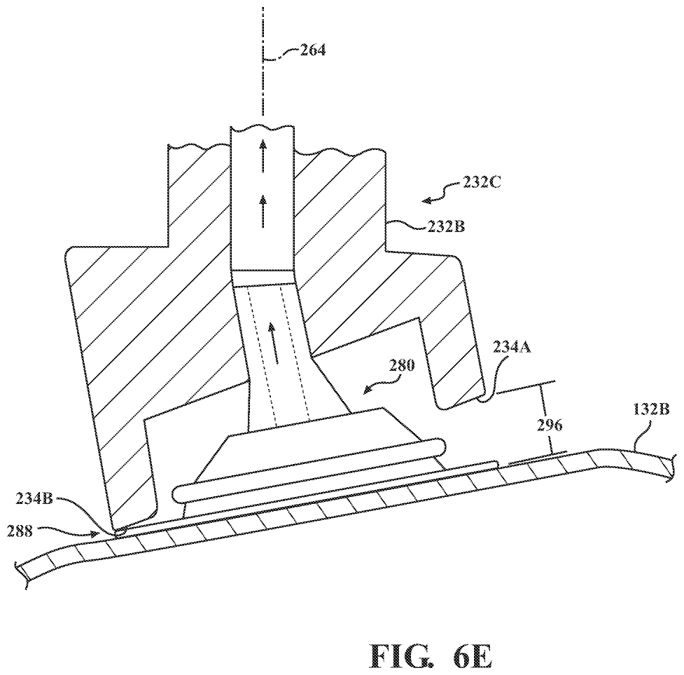

In one example, system 100 control system 350 processor 352 (FIG. 6) may compare the collected and transferred glass panel 132 data from the imaging devices to the stored in memory glass panel quality control details, and or the above mentioned vehicle and assembly process information, and generate predetermined signals to the robot 130 or other equipment in the assembly cell 102, 104. In one example, the detected or imaged glass panel 132 next to be installed may be compared to data also collected on the vehicle positioned in primary cell 102 to verify, for example, that the next to be installed glass panel 132 is the proper glass panel to be installed on the vehicle 120 positioned in primary cell 102. Other glass panel and/or vehicle collected data may be compared to predetermined vehicle or assembly process control verifications or system defaults or abnormalities. Additional or alternate sensors 154 and quality control processes known by those skilled in the art may be used to suit the particular application.

As further described below, the sensors 154 may be connected to and onboard the end effectors 200, or they may be separate, stand-alone units in the primary cell 102 adjacent exit end 150 as generally described. In one example further described below, sensors 154 installed on end effector 200 may be used to image and/or otherwise scan the predetermined position on the vehicle 120 that the engaged glass panel 132 is to be installed to ensure proper position and installation of the glass panel 132 relative to the vehicle 120. It is understood that sensors 154 may be positioned in, or are in communication with, other areas of station 110 other than the exit area 150, for example, entry end 146, or conveyor 140, to suit the particular application as known by those skilled in the art.

Still referring to FIG. 1, backup decking cell 104 is positioned downstream of primary cell 102 along the path of travel 124. Backup cell 104 includes one or more of the decking stations (two shown) including one or more of the devices described above for primary cell 102. In one example, backup cell 104 may be used for glass installation inspection, for assembly line 116 maintenance, and/or other functions as known by those skilled in the art. For example, if robot 130C is down for maintenance or repairs and cannot install a glass panel 130 windshield, robot 130E or robot 130F positioned in backup cell 104 may be used to avoid stoppage of the system 100. It is understood that decking system 100 may not include a backup cell 104, or may include additional backup or alternately operable cells (not shown) to suit the particular application as known by those skilled in the art.

In operation, in exemplary system 100, as further described below for end effector 200, glass panels 132 are sequentially positioned in the entry end 146 of panel transition area 136. Conveyor 140 selectively moves panels 132 positioned on the conveyor toward exit end 150. Sensors 154 may be used to detect predetermined metrics of the glass panel positioned in exit end 150 before engagement of the panel 132 by robot 130. If the detected panel 132 satisfies predetermined metrics as determined by control system 350, robot 130 engages the panel 132 through end effector 200 as further described below. The robot 130 then manipulates, positions, and installs the engaged glass panel 132 in the predetermined position on the vehicle, for example the windshield in the vehicle 120 vehicle windshield opening. They glass decking system 100 is advantageous in that through use of end effector 200 described below, the robots 130 may engage and install differently configured glass panels in different predetermined areas of vehicle 120 without having to stop the system 100 and change or alternately configure the end effectors 200 to accommodate different vehicles positioned in the primary cell 102.

### Adaptable End Effector

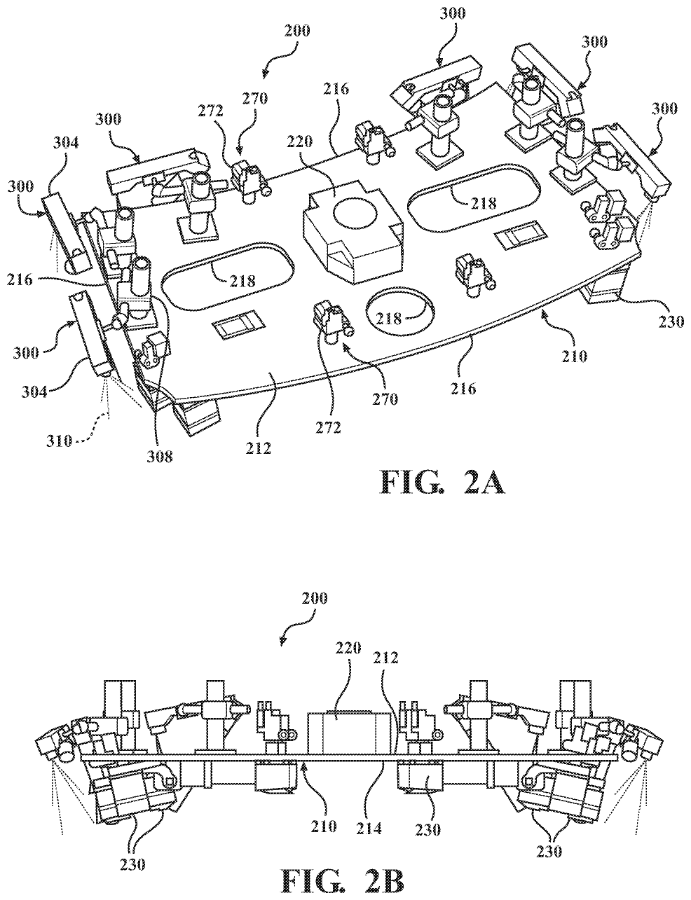

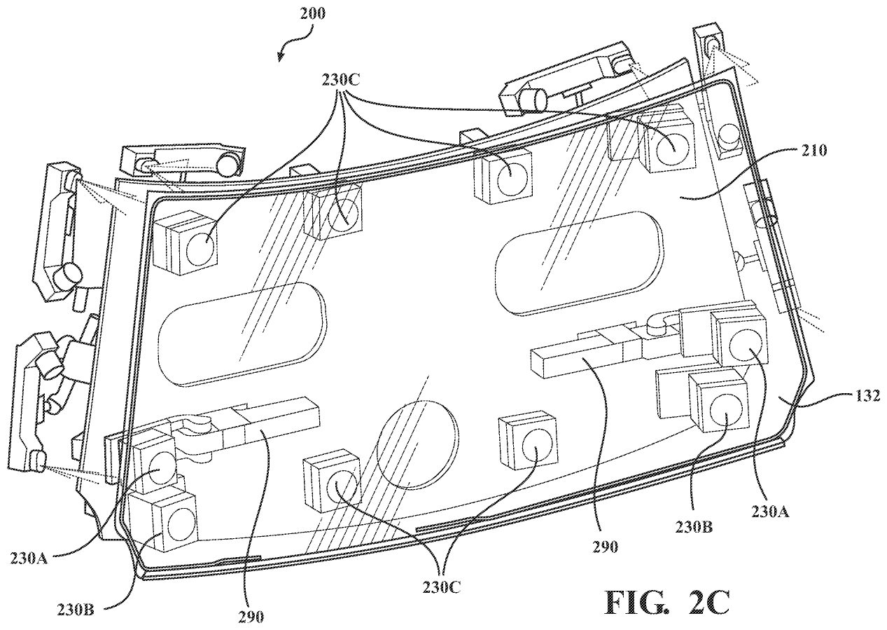

Referring to FIGS. 2A-7, examples of an adaptable end effector 200 useful with the exemplary glass decking system 100, are shown. The exemplary end effector 200 is useful for picking up or engaging, manipulating in three-dimensional space, and disengaging or releasing in a predetermined position and orientation, a wide range of components, for example glass panels 132, or other objects or components. It is understood that the end effector 200 may be used with systems other than glass decking system 100, devices other than programmable, multi-axis industrial robots 130, and panels other than vehicle glass panels 132.

Referring to FIGS. 2A and 2B, exemplary end effector 200 includes a base plate 210 (plate); a connector 220; one or more, and preferably a plurality of, integrated engagement blocks 230; sensors 300; and an air/vacuum port assembly 320.

Referring to the FIGS. 2A and 2B example, plate 210 is single or unitary, rigid plate which serves as a frame or base support for the other components of the end effector 200. Plate 210 can be planar (shown), curved, or stepped with different transition or mounting surfaces. Exemplary plate 210 includes an upper surface 212, a lower surface 214, and a perimeter 216. Plate 210 can be made from ferrous or non-ferrous metals such as steel or aluminum, composites, or polymer materials. Plate 210 can include one or more apertures 218 to decrease weight while remaining rigid or semi-rigid. Plate 210 perimeter 216 can vary to configure the plate 210 to meet the particular component to be engaged, for example glass panels 132, or other objects, to suit the particular application as known by those skilled in the art.

In one example, a single plate 210 is sized, shaped and configured to be useful for all types of components, for example glass panels 132, that will be installed in a particular primary 102 or backup cell 204. The exemplary single plate 210 is also useful regardless of the type or model of product, for example different vehicles 120 and/or different models of a particular vehicle 120, to receive differently configured glass panels 132. Although described as a single or unitary plate, plate 120 may be made from multiple plates connected together to form a rigid plate to support the end effector 200 components described below.

Exemplary end effector 200 further includes a connector 220. In one example where end effector 200 is used with a robot 130, connector 220 is configured to connect to a wrist or mounting plate of a robot (not shown). In one example, connector 220 includes connection devices, for example quick-connect couplings, whereby on engagement of the connector 220 to the robot 130 wrist, electrical power, data, and fluid lines or cables from the robot 130 are placed in communication with the connector 220 and other devices of the end effector 220. For example, the robot connection lines, cables, or conduits may provide one or more of electrical power supply; electronic and/or digital signal cables; and/or pressurized air, water, hydraulic fluid or lubricant; and/or other supply of materials or services from the robot 130 to the end effector 200 to support the function of the end effector 200 components as further described below and known by those skilled in the art. Connector 220 can take other forms and configurations to suit the particular automated, or semi-automated, device to suit the particular application as known by those skilled in the art.

Integrated Engagement Blocks

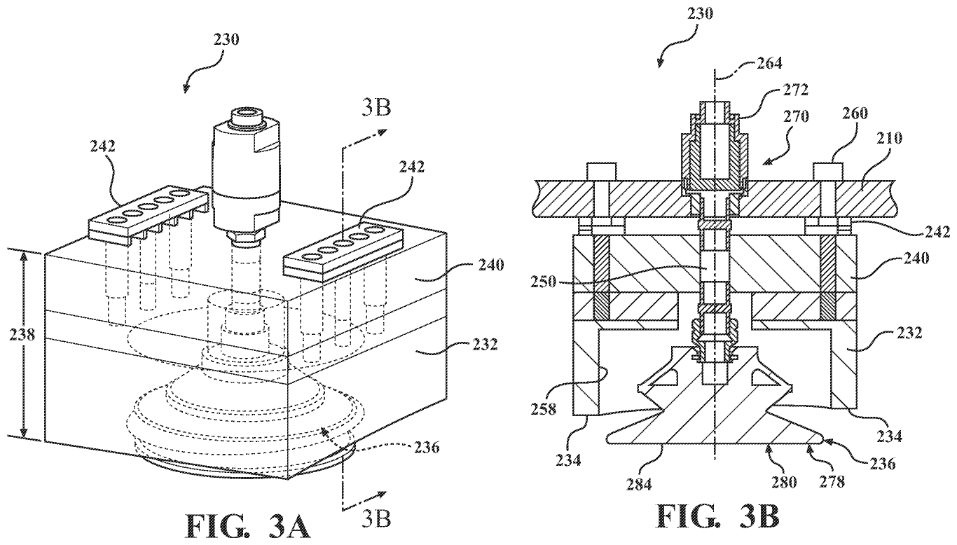

As best seen in FIGS. 3A-6E, examples of an integrated engagement block 230 (block) are shown connected to the lower surface 214 of plate 210 (10 shown). The blocks 230 are selectively used to releaseably engage and secure a component or object to the end effector 200, for example a glass panel 132. The blocks 230 are particularly, but not exclusively, useful for releaseably engaging panels of varying contour or configuration without having to change the end effector, or stop the assembly process to reconfigure the end effector 200, for example when a vehicle model change occurs.

The number and positioning of the blocks 230 connected to plate 210 may vary based on the types and/or models of the glass panel 132 it is configured to engage. For example, end effector 200 plate 210 configured for a large sport utility vehicle (SUV) windshield may include a greater number of multifunctional blocks 230 than a plate 210 that is configured for a small sedan backlight. The position of the blocks 230 may also vary on plate 210 to suit the particular object, for example glass panel 132. For example, for a smaller glass panel 132, for example quarter glass, one or more of the blocks 230 may be positioned closer to a center of the plate 210 versus around the plate 210 perimeter 216 for a larger glass panel 132.

As best seen in FIGS. 3A, 4A, 5A, and 6D each exemplary block 230 includes a locating element 232, 232A, 232B and a holding element 236 in a single integrated module or device. Conventional end effectors useful for glass panels often included separate locating devices, for example bumpers or blocks, from holding elements, for example suction cups. These conventional designs suffered from disadvantages in that these separate bumpers and suction cup holders may work against each other and generate opposing forces on the glass panel 132 which can deform or alter the shape or geometry of the glass panel while engaged with the end effector. This can result in damage to the glass panel 132 or affect the installation process and/or ultimate placement on the vehicle 120, for example defective placement of the glass panel on the vehicle from a design or optimal position. Conventional locating panel or component bumpers or blocks further suffered from disadvantages that they were often easily moved (for example positionally moved through use or by impact by equipment or objects), and/or operations personnel, from a proper design position which causes dimensional inaccuracies when the panel is engaged by the end effector. This results in inaccurate positioning, either initially or over time, and improper positional placement of the panel on the product or vehicle leading to costly quality problems for the product or vehicle, for example water leaks and wind noise through the vehicle window glass panels.

End effector 200 integration of the locating element 232 and the holding element 236 reduces these conventional opposing vector forces on the overall glass panel 132 geometry and improves on the disadvantages in conventional end effectors. Through use of the integrated blocks 230, locating elements 232 and NC surface abutment surfaces 234, improved accuracy and repeatability in panel engagement, handling, and installation of the panels, for example glass panels 132, on the vehicles 120.

In one example of block 230 shown in FIGS. 3A and 3B, integrated block 230 includes an adapter 240 and a mounting plate or shims 242 (two shown) used to connect block 230 to the lower surface 214 of plate 210 as best seen in FIG. 2C. The mounting plate 242, or additional or alternate spacer devices (not shown), may be used to axially distance, and/or angularly orient, adapter 240 from the plate 210 to suit the particular application as known by those skilled in the art.

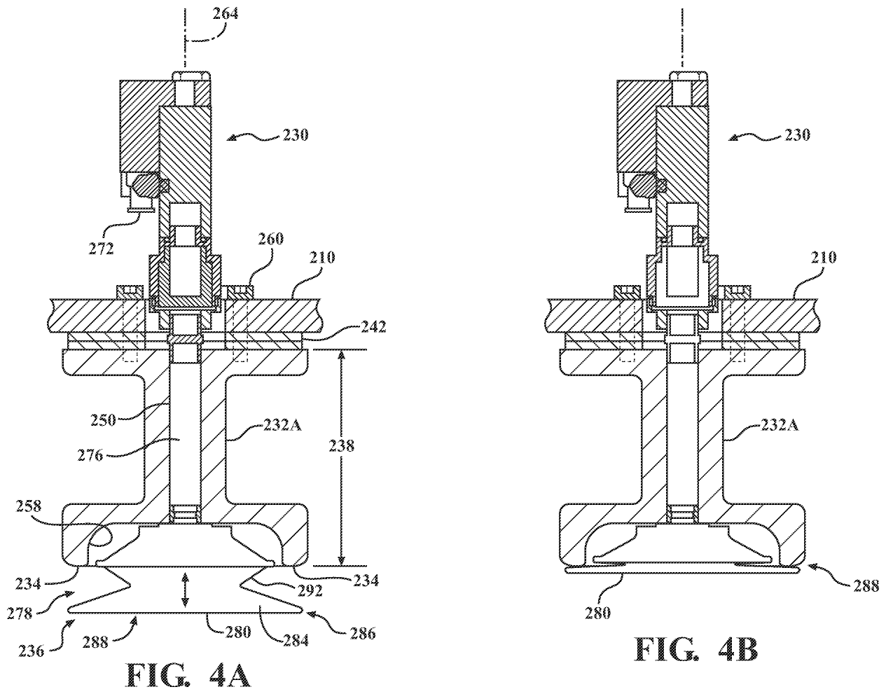

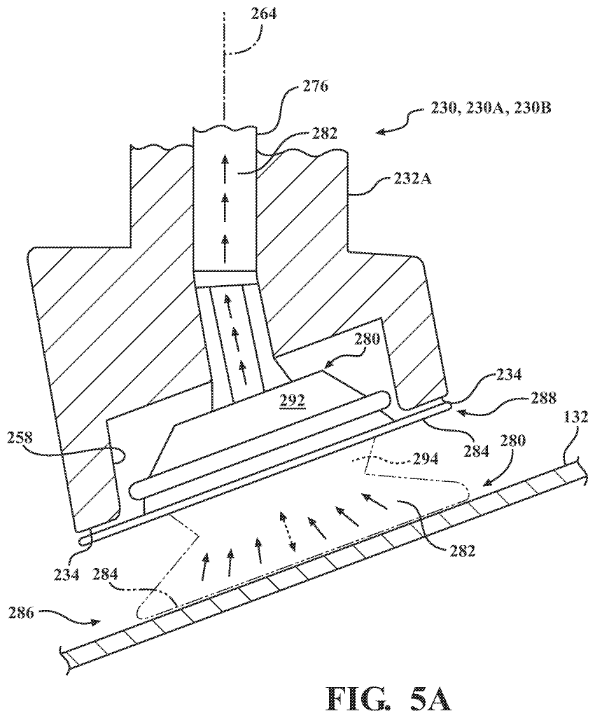

Adapter 240 may be made from ferrous, non-ferrous, composite, polymeric or elastomer materials and includes one or more through bores 250 for structures to support the operation of the holding element 236 as described further below. Adaptor 240 many have alternate, shapes, sizes, configurations and materials to suit the particular application, for example glass panels 132, as known by those skilled in the art. In one example as shown in FIGS. 4A and 4B, adaptor 240 and locating element 232 may be a single, integral component.

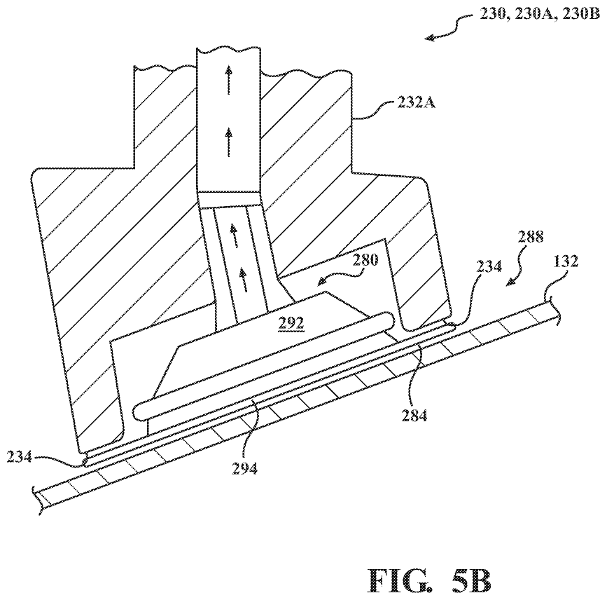

Still referring to FIGS. 3A and 3B, each block 230 locating element 232 connects to the adapter 240 opposite the plate 210 as generally shown. In one example best seen in FIGS. 3B and 5A, locating element 232, 232A, 232B includes an abutment surface 234 operable to abuttingly engage or contact the object or panel to be engaged and secured by end effector 200, for example glass panel 132, as further described below. Exemplary locating element 232 further defines a central opening 258 sized to receive and allow axial movement of the holding element 236 as further described below.

Exemplary locating element 232 is connected to the adaptor 240 (or plate 210) by one or more, or a plurality, of bolt fasteners 260 positioned through the plate 210, the adaptor 240 and into the locating element 232 to secure the multifunctional block 230 to the plate 210. Other devices and methods to connect locating element 232 to adaptor 240, and/or block 230 to plate 210, to suit the particular application may be used as known by those skilled in the art.

Referring to FIGS. 4A and 4B, an alternately configured integrated block 230 is shown. In the example, the locating element 232A is alternately configured to be a single component versus the separate adaptor 240 and locating element 232 shown in FIGS. 3A and 3B. Locating element 232A includes the same or similarly constructed components and functions described for locating element 232 as described above. As explained for end effector 200 including adaptor 240 and locating element 232 in FIGS. 3A and 3B, locating element 232B can position the abutment surface at different axial and angular orientations relative to plate 210 to suit the particular application and panel to be engaged.

In one example, locating elements 232, 232A, 232B are made from a rigid material, for example aluminum, which may be precisely and accurately formed and/or machined to close tolerances. Other materials, or combinations of other materials, for example rigid materials in combination with semi-rigid or semi-compressible materials, may be used to suit the particular application as known by those skilled in the art. As noted for the example shown in FIGS. 3A and 3B, the locating element can be constructed from multiple pieces, wherein, for example, the lower portion which includes abutment surface 234 is a softer, non-marring and/or semi-compressible material and is connected to a rigid upper portion for example adaptor 240, for secure connection to plate 210. As further described below and illustrated in FIGS. 5B, 6D and 6E, use of a rigid locating element 232, with a holding element 236 having a soft and/or semi-compressible lower portion 294, prevents undesirable markings or scratches to the glass panel 132 while maintaining a rigid, dimensionally accurate locating element 232 and abutment surface 234 having an NC surface.

In one example of end effector 200, a holding element actuator 270 is used to selectively operate or activate each of the holding elements 236 used to engage and disengage a panel, for example glass panel 132. In one example, one or more actuators 270 are mounted to plate 210 and is in communication with a pressurized air vacuum source, for example provided from the robot 130 through connector 220 and air hoses to the integrated blocks 230 to selectively move the holding elements 236 as further described below. In the example, a manifold (not shown) with an air valve for each block 230 is used. Each valve is in communication with the control system 350 to open or close the valve selectively providing an air vacuum pressure to the selected blocks and the respective holding element 236. Other centralized actuator 270 systems may be used as known by those skilled in the art to suit the particular end effector 200 and system 100.

Referring to FIGS. 3B and 4B, each block 230 further includes complimentary components for selected receipt and/or transfer of a pressurized fluid, for example the air pressure vacuum force, in a direction axially away from holding element 236 toward plate 210, to selectively axially move and position the holding element 236 relative to the locating element 232 and/or plate 210. In the FIGS. 3B and 4A examples, block 230 includes a fluid inlet port 272 in fluid communication with a fluid conduit 276. Inlet port 272 may be configured with quick connect couplings for receipt of fluid hoses (not shown), or other structures, to form a fluid tight, for example air tight, connection between the inlet port 272 and end effector connector 220. Inlet port 272 may include other fluid fittings, structures and configurations as known by those skilled in the art. As best seen in FIGS. 3B and 4A, inlet port 272 is positioned to extend through plate 210 upper surface 212 and be accessible from the plate upper surface 212.

In the FIGS. 3A-6E examples, end effector 200 is configured to engage glass panels 132. In the example, holding element 236 is in the form of an extendible pneumatic suction or vacuum cup 280 operable to selectively engage and disengage a glass panel 132. Suction cup 280 is connected to and in fluid communication with actuator 270 and fluid conduit 276 which is operable to selectively move vacuum cup 280 between a first position 286 (cup 280 extended in FIGS. 3B, 4A and 5A (in dashed line)), and the second position 288 (cup 280 retracted toward the locating element in FIGS. 3A, 4B and 5B).

In the example holding element 236 shown, suction cup 280 includes an upper portion 292 and a lower portion 294 which includes the engagement surface 284. The engagement surface 284 may further include one or more, or a plurality of, through air holes such that on application of a vacuum air force 282 from an air vacuum source through the through air holes in the engagement surface 284, a distributed, strong air vacuum force 282 is produced at the engagement surface 284 to engage or grip, or alternately disengage or release, the object or panel to be secured by end effector 200, for example glass panel 132.

As best seen in FIG. 5A, in one example of operation, suction cup 280 lower portion 294 is normally, or biased, to the first position 286 where the lower portion 290 engagement surface 284 axially extends beyond the locating element abutment surface 234 (shown in dashed line). On application of a vacuum air force 282 from the robot 130 through the connector 220, and actuator 270, suction cup lower portion 294 and engagement surface 284 are forcibly axially drawn up or retracted toward the suction cup upper portion 292 to a second or retracted position shown in FIG. 5A (in solid line), 5B. As best seen in FIGS. 5A, 5B, 6D and 6E, examples, in the holding element 236 second position 288, at least a portion of suction cup engagement surface 284 is positioned between the abutment surface 234 and the glass panel 132, and is in direct contact and in overlapping orientation with the abutment surface 234 (small spaces shown between engagement surface 284 and abutment surfaces 234 shown in FIGS. 5A and 5B are for ease of illustration only). In this exemplary manner, the abutment surface 234 receives and abuttingly contacts or engages the glass panel 132, but may not be in direct physical contact with the glass panel 132 as shown. On release or cessation of the pressurized vacuum force 282, the suction cup lower portion 290 automatically returns to the first or extended position 286 shown in FIGS. 3A, 4B and 5A (in dashed line).

It is understood that actuator 270 and holding element 236 may be alternately configured and functionally operate to suit the particular application as known by those skilled in the art. For example, a combination of selectively applied forced, pressurized air toward the holding element (not shown), and the described air vacuum pressure force 282, may be used selectively, or in sequenced combination, to alter the position of the holding element 236 to and from the first 286 and second 288 positions. It is further understood that alternate forms of fluid pressure other than the described vacuum force 282, may be used to axially move holding element 236, and engage the holding element to the panel or object, for example, glass panel 132, to suit the particular application.

Referring to FIGS. 2C and 6, examples of end effector 200 configured to selectively engage and disengage panels, for example glass panels 132, of different geometric dimensions and/or contours are shown. Referring to FIG. 2C, three differently configured engagement blocks, first integrated block 230A, second integrated block 230B and combination integrated block 230C are shown which are useful to engage at least two differently configured glass panels 132, for example a vehicle windshield for two different vehicle 120 models having a different size or curved shape or contour.

In the FIG. 2C end effector 200 exemplary configuration, first blocks 230A are configured and positioned on plate 210 to engage a first glass panel, and second blocks 230B are configured and positioned on plate 210 to engage a second glass panel, different in, for example, contour. As best seen in the FIGS. 5A and 5B example, and using the first block 230 and the first glass panel as an example, the locating element 232 abutment surface 234 is shaped or contoured, for example, to be a numerical control and/or precision machined surface (NC surface) to be the same as, similar to, and/or corresponding to, the surface or contour of the first glass panel 132 that will contact and/or be received by the abutment surface 234 when the first glass panel is engaged by the respective first block 230A suction cup 280 and moved to the second position 288 as best seen in FIG. 5A (small spaces or gaps shown for ease of illustration only).

In one example, the abutment surface 234 is a numerical control and/or precision-machined surface (NC surface). In one example, this abutment surface 234 NC surface is accurately and precisely obtained through a computer numerical control (CNC) milling or machining device using the glass panel 132 design data (for example computer aided design (CAD) data) to be the same as, similar to, and/or corresponding to, the shape or surface contour of the glass panel 132 (or other component to be engaged) taking into account other common design factors and tolerances. This has the benefits of proper 3-dimensional engagement and handling, and installation of the glass panel 132 on vehicle 132. This results in a more dimensionally and positionally robust end effector 200, and an more accurate, precise and repeatable process increasing quality of the finished product, for example vehicle 120. Other devices or methods to form or shape the abutment surface 234 to suit the particular application known by those skilled in the art may be used.

In the example illustrated, the first block 230A abutment surface 234 is in abutting contact or engagement with the first glass panel (and suction cup 280 engagement surface 284) all around, or nearly all around, the perimeter of the abutment surface 234. In one example of operation, when end effector 200 (and system 100), is programmed and executing to next engage the first glass panel, control system 350 will send a signal to the holding element actuator 270 to selectively provide the air vacuum force 282 to only the first blocks 230A.

In the FIGS. 5A and 5B example, the second blocks 230B abutment surface 234 would alternately be a numerical control and/or precision machined surface (NC surface) to be the same as, similar to, and/or corresponding to, the surface contour of the second glass panel that will contact and/or be received by the abutment surface 234 when the second glass panel is engaged by the respective second block 230B suction cup 280 and moved to the second position 288 as similarly described for first block 230A. In one example of use of first 230A and second 230B blocks for a first and second glass panel, the locations, positions of the first 230A and second 230B blocks on the plate 210 lower surface 214 are coordinated to ensure engagement of the respective first or second glass panel.

Further, the axial and angular positions of the first 230A and second 230 blocks locating element abutment surfaces 234 are coordinated so as to not interfere with engagement of the other of the first of the second glass panel. In one example where spatial or dimensional interference between the first block 230A and second block 230B exists or cannot be accommodated by the positions of the abutment surfaces 234 alone, one or more block actuators 290 are used to selectively and automatically move one or more of the first 230A (shown in FIG. 2C) or second 230B blocks axially toward the plate, or otherwise to an alternate position to remove the interference condition. For example where an interference condition exists (engagement of the first glass panel is interfered with by one or more second blocks 230B), if end effector 200 is to next engage a first glass panel using first blocks 230A, one or more of the second blocks 230B may be moved from an active (in position for engagement of second glass panel) to an alternate or inactive position by an actuator 290, controlled by control system 350, to remove the interference condition. Other devices and methods to accommodate and resolve spatial interference conditions may be used as known by those skilled in the art. Although described as end effector 200 using first 230A and second 230B blocks to accommodate a first and a differently configured or contoured second glass panel, it is understood that additional blocks 230 configured to accommodate a third or a fourth differently configure panel(s) may be used to suit the particular application and system 100 as known by those skilled in the art.

Referring to FIGS. 2C and 6A-E, an example of end effector 200 using one or more combination integrated blocks 230C are shown. Referring to the FIG. 2C example, one or more combination blocks 230C (six shown) may be used in combination with first blocks 230A and/or second blocks 230B to suit the desired engagement of differently configured or contoured glass panels 132 as further described below.

Referring to the FIGS. 6A-6E example, an alternate example of an end effector 200 configured to alternately engage a first glass panel 132A and a smaller, differently configured and/or contoured second glass panel 132B (shown in dashed line) is shown (plate 210 shown as transparent for ease of illustration and explanation). As best seen in FIGS. 6 and 6A, exemplary end effector 200 uses a combination of one or more first integrated blocks 230A (two shown), one or more second integrated blocks 230B (two shown) and one or more combination blocks 230C (two shown).

Referring to the FIG. 6D example, locating element 232 abutment surface 234 includes a first abutment surface portion 234A which is numerically controlled and/or precision machined (NC) to be the same as, or similar to, the contour of the first glass panel 132A, when the first glass panel 132A is engaged by the suction cup 280 and moved to the second position 288. Exemplary abutment surface 234 includes a second abutment surface portion 234B which is numerically controlled and/or precision machined (NC) to be the same as, or similar to, the contour of the second glass panel 132B when the second glass panel 132B is engaged by suction cup 280 and moved to the second position 288.

As shown in the FIG. 6D example, on engagement of the combination block 230C suction cup 280 and movement to the second position 288, first glass panel 132A only abuts or contacts locating element first abutment surface portion 234A (small gap or space shown between first glass panel 132A, suction cup engagement surface 284, and first abutment portion 234A for ease of illustration only). In the example of engagement of a first glass panel 132A, there remains a spatial gap or distance 296 between the first glass panel 132A and the second abutment surface portion 234B as shown. Spatial distance 296 may be on or between 0.5 millimeters (mm) to 20 millimeters (mm) or more in length depending on the alternate glass panels 132 to be engaged, the geometry or configuration of the specific end effector 200, or other metrics. Other spatial distances 296 outside of this dimensional range, lesser and/or greater, may be used depending on the applications and metrics described.

Referring to the FIG. 6E example, the combination block 2C shown in FIG. 6D is shown engaged with the alternate second glass panel 132B. In a similar manner as described for engagement of first glass panel 132A in FIG. 6D, engagement of the second glass panel 132 abuts or contacts only the second abutment surface portion 234B (small gap or space shown between second glass panel 132B, suction cup engagement surface 284, and second abutment portion 234B for ease of illustration only). The spatial gap or distance 296 is similarly shown between the second glass panel 132B and the first abutment surface portion 234A. It is understood the spatial distance 296 may vary at the first 234A and second 234B abutment surface portions depending on the glass panels and metrics described above.

FIG. 6C is a schematic illustration showing when a first glass panel 132A is engaged, the first integrated blocks 230A and the combination integrated blocks 230C first abutment portions 234A are in abutting contact or engagement with the first glass panel 132A leaving the spatial gap 296 with respect to the combination block 230C second abutment portions 234B. Similarly, on alternate engagement by end effector 200 with the second glass panel (shown in dashed line), the second integrated block 232B and the combination block 230C second abutment surface portion 234B are in engagement with the second glass panel 132B leaving the spatial gap 296 between the second glass panel 132B and the first abutment portion 234A. In one example, the robot 130 may take an alternate path of travel to position and/or orient the end effector 240 to optimally position the plate 210 and holding elements 236 depending on the glass panel 132 to be engaged. Other devices and/or configurations of combination blocks 230C to suit the application and performance requirements of the end effector 200, or system 100, known by those skilled in the art may be used. It is understood that the number and position of combination blocks 230 relative to plate 210 may vary to suit the particular application as known by those skilled in the art.

Although shown that combination integrated blocks 230C are used in combination with both first 230A and second 230B blocks, it is understood that combination blocks 230C may be used with either first 230A or second 230B blocks, or end effector 200 may be configured with only combination blocks 230C to suit the particular application. It is further understood that end effector 200 may not include any combination block 230C.

Referring to the FIGS. 2A and 2B example, end effector 200 includes at least one, and preferably a plurality, of sensors 300 connected to base plate 210 operable to detect, scan, or otherwise read or collect data on at least one predetermined metric or condition regarding the end effector 200, the panel to be engaged, manipulated and released, and/or the vehicle 120 the panel is to be installed. In the example shown, a plurality of sensors 300 (six shown) are connected to the upper surface 212 of plate 210. Each sensor 300 may be a device such as a single image camera, video camera, or other type of sensor, for example, laser, ultrasonic, infrared, or other sensors, or combinations thereof, to suit the particular application and metric to be detected. Sensors 300 may be, or include, sensors 154 described above for system 100. Other sensors (not shown) may be used to detect physical contact, for example force or pressure sensors.

Each sensor 300 is in electronic/digital communication with, and is capable of sending and receiving signals, through cables or wirelessly, between the local or central control system 350 (FIG. 7). The local or central control system 350 is operable to receive the sensor 300 signals, compare the signals or detected data to stored in memory data pertaining the particular metric, and send signals to the local control system, for example on the robot 130 or control system onboard the end effector 200, to control operations of the robot 130 and/or the end effector 200. In one example described above, the sensors 300 and control system 350 work cooperatively to detect the type or configuration of the glass panel 132 to be next engaged by the robot 130, and active through the holding element actuator the vacuum force for the appropriate integrated blocks 230 to engage the detected and verified glass panel.

In the FIGS. 2A and 2B exemplary sensors 300, one or more of the sensors 300 includes an adjustable arm 304 moveable in 3D coordinate x, y and z space relative to a post 308 mounted to the upper surface 212 of plate 210 as generally shown. A sensor lens 309 (FIG. 6) or other sensor input/output device having a field of vision 310 is positioned on a distal end of the arm 304 distanced from the post 308. The lens may be positioned in x, y and z coordinate space to suit the particular metric to be detected. Other devices or structures to mount and position the sensor 300 relative to the plate 210 and/or the glass panel 132 may be used to suit the particular application as known by those skilled in the art.

In one example, sensor 300 is used to detect and/or recognize the type of panel or component to be engaged prior to engagement by the robot 130 and end effector 200, for example, to confirm that the glass panel 132 is the proper glass panel to be engaged and/or installed in vehicle 120. Alternately, or in combination, sensors 300 may be used to identify the type of glass panel 132 prior to engagement by the robot 130 and end effector 200 in order to activate the vacuum force 292 to the appropriate integrated blocks 230 for the identified and verified glass panel 132. Other predetermined metrics detected by sensors 300 may include the size, dimensions, contour, tint or other metrics of the glass panel 132. Sensors 30 may also detect and/or measure distances, force or pressure between the glass panel 132 and the integrated blocks 230, as well as other metrics known by those skilled in the art. Examples of an imaging recognition systems and device are disclosed in U.S. Pat. Nos. 8,150,165 and 8,923,602 which are incorporated herein by reference.

In one example of operation, as robot 130 moves the end effector 200 into the predetermined location of the panel, for example glass panel 132, to be engaged or otherwise manipulated, the sensor 300 (or sensors), would capture an image, or otherwise detect, the glass panel 132 prior to the end effector 200 engaging the glass panel 132 with the integrated blocks 230. In one example, the captured image data would be sent to the end effector control unit, or local or centralized control unit, 350 for comparison to previously stored in memory image data for a variety of components. For example, if the glass panel 132 detected data is not the type of glass panel 132 the end effector 200 is set or programmed to engage, a fault or other alarm may be issued by the control unit to alert a broader control system or operator. On detection of such a fault, a visual or audible signal may be generated and the robot 130 and/or end effector 200 may stop operations until the fault status is resolved. Alternate types of sensors 300 and/or predetermined metrics to identify the object or glass panel 132 to be engaged include use of a laser scanner to scan indicia printed on the glass panel which provides data of the type of glass panel. This identification data is sent to one of the control systems 350 mentioned, is compared, and/or return signals sent to execute actions as described above. Still further examples include comparing the detected glass panel data to stored in memory build process data, for example comparing the detected glass panel 132 is the proper glass panel for the vehicle 120 positioned in, or scheduled for, the primary cell 102.

In another example of use of sensors 300, one more sensors 300 may be used to detect the locational positioning of the glass panel 132, for example positioned in the conveyor 140 exit end 150, or the glass panel position relative to a holding fixture, to detect and determine if the glass panel 132 is in a proper position to be engaged by the end effector 200. Any mis-position or misalignment of the glass panel 132 to be engaged prior to attempted engagement, can be remedied by control system 350 adjusting the position or path of travel of the robot 130 to properly position the end effector 200 relative to the glass panel 132. This detection by sensors 300 and/or automatic adjustment by control system 350 can prevent damage to the glass panel 132, the end effector 200, or robot 130. Other predetermined metrics that one more sensors 300 may be used for is determining actual or positive engagement of the glass panel 132 and/or positive disengagement of the glass panel 132 from the end effector 200, prior to movement of the robot 130 along the next predetermined path of travel. Other uses and detection metrics for sensors 300 for end effector 200 may be used to suit the particular application as known by those skilled in the art.

In one example of operation of end effector 200, end effector 200 is connected to a preprogrammed, multi-axis robot 130 described above. On receiving a signal from the control system 300, the robot 130 moves the end effector in proximity to the next panel, for example glass panel 132, that is to be engaged and installed on vehicle 120 (or other product). On one example, sensors 300 are used to detect a predetermined metric of the glass panel, for example verify the glass panel is the proper glass panel 132 for the vehicle positioned in the primary cell 102. On verification of the proper glass panel 132 to be engaged, for example a first glass panel 132A, the control system 350, will signal the robot 130 to position the end effector 200 in the proper orientation to engage the glass panel with the integrated blocks 230.

In one example, the appropriate integrated blocks, for example first blocks 230A, respective suction cup 280 engagement surfaces 284 will be in the first position 286. The robot will then be signaled to move the end effector 200 until suction cup engagement surfaces are in contact with the first glass panel 132A. The control system 350, through holding element actuator 270, will activate or otherwise expose the first integrated blocks 230A to the vacuum force 292 thereby engaging the first glass panel 132A with the engagement surface 284 and move the suction cup 280 and engaged first glass panel 132A into abutting engagement or contact with the first integrated blocks 230A abutment surfaces 234 to properly positon and secure the first glass panel to the end effector 200. In an example where end effector includes combination blocks 230C, the first glass panel will also abuttingly engage the first abutment portions 234A of the combination integrated blocks.

In one example, on verification that the first glass panel 132A is physically engaged by end effector 200, the control system will signal the robot to move the engaged first glass panel toward vehicle 120 for positioning and installation of the glass panel in a predetermined location on the vehicle 120, for example in the vehicle windshield opening. As described for system 100 above, the robot 130 may move relative to the vehicle 120 to be in communication with the predetermined vehicle opening. In one example, sensors 300 are used to detect the vehicle predetermined opening for proper orientation of the first glass panel 132A relative to the vehicle 120, make any adjustments, and install and disengage the first glass panel. A similar process would be conducted for alternate glass panels, for example second glass panel 132B. The robot 130 and end effector 200 would then receive a signal to return to the exit end 150 to begin the process to engage the next glass panel. Other methods, including the addition or alternate sequence of steps, may be used to suit the particular application as known by those skilled in the art.

### Control System

Referring to FIG. 7 and example of a control system 350 is shown. As mentioned above, a control system, or multiple control systems 350, may be used with system 100 and end effector 200. In one example where a control system 350 is onboard or connected to the end effector plate 210, the end effector 200 may be a “smart” end effector whereby the onboard control system 350 includes preprogrammed instructions to operate the end effector 200 and/or the robot 130 according to the preprogrammed instructions, for example instructions for operation relative to a vehicle 120 model A and a vehicle 120 model B.

In the end effector 200 onboard control system 350 example, for example, end effector 200 control system 350 is in communication with the robot 130 control system 350. In the example, the onboard control system 350 serves to control movement and operations of the end effector 200 and robot 130 in the examples described above. The robot 130 control system, or the onboard control system 350 may send and receive signals from a local control system 350, for example a local control system that monitors and controls the automated or semi-automated equipment in the primary 102 and back-up 104 cells as described for FIG. 1. A central control system 350, for example a central facility control system, may be in communication with the end effector 200 control system 350, and/or the robot 130 control system to, for example, monitor and/or coordinate operations in the local primary cell 102 in relation to overall facility operations, for example the product build or assembly schedules for vehicles 120. Examples of suitable “smart” end effectors and communication systems can be found in US Patent Application Publication Nos. 2010/0180711A1 and 2010/0241260A1 and U.S. Pat. Nos. 8,843,221 and 8,818,531 all incorporated herein by reference.

Alternately, the local or centralized control system 350 may include the preprogrammed instructions, operating systems, software and hardware to detect metrics described above and send signals to the robot 130 and/or end effector 200 to operate the robot 130 and end effector 200 in the examples as described above. In one example of a local control system 350, one or more robot cabinets may be positioned proximate to the primary 102 and backup cells 104.

Referring to FIG. 7, an example of a control system 350 which may serve as the end effector 200 control system, robot 130 control system, or a local or central control system. Exemplary control system 350 includes a computing device, or multiple computing devices, working cooperatively. The exemplary control system 350 computing device includes common hardware components, including but not limited to, a central processing unit (CPU) 302, data memory storage device 354, one or more controllers (including but not limited to programmable logic controllers (PLC)) 356, input/output devices 358, transmitter and receiver 360 for sending and receiving wireless data signals, actuators 362 (for example holding element actuator 270, electric motors, solenoid valves, air compressors), and sensors 364 (for example sensors 154 and sensors 300). These hardware components are in data signal communication with one another, either through hard wire connections or wireless communication protocols, through a bus 366 or other suitable hardware. Control system 350 is powered by the power source 370, for example electrical power provided to the facility, or rechargeable batteries. As noted above, electrical power from power source 370 may be provided to the robot 130 and the end effector 200. Other control system 350 hardware, software, operating systems and other devices may be included to suit the particular application as known by those skilled in the art.

Examples of wireless communication networks that may be used to communicate between the control system(s) 350 and components described herein include, but are not limited to, large area networks (LAN), a campus area network (CAN) or other networks suitable for the application as described as known by those skilled in the art. Examples of wireless communication networks, systems and protocols usable with system 100 and end effector 200 include wireless routers for communication based on IEEE standard 802.11 (also known as wi-fi). Other wireless communication protocols, for example BLUETOOTH, may be used. Other wired communication systems and components for communication may be based on IEEE standard 802.3 (also known as the Ethernet) may be used in certain applications. Other forms of communication networks, wired and wireless communication protocols, systems and devices known by those skilled in the art may be used.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An adaptable end effector for use in engaging and disengaging alternately configured panels, the end effector comprising:
a base plate having an upper surface, a lower surface and a perimeter;
a plurality of integrated blocks connected to the base plate and operable to selectively engage and disengage at least one panel having a contour, each of the plurality of integrated blocks further comprising:
a locating element connected to the base plate, the locating element including an abutment surface operable to abuttingly receive an engaged at least one panel;
a holding element engaged with the locating element operable to selectively and releaseably engage the at least one panel, the holding element selectively movable between a first position and a second position relative to the locating element; and
a holding element actuator in communication with the plurality of integrated block holding elements operable to selectively move the respective holding elements between the first and second position and selectively engage and disengage the at least one panel.

2. The end effector of claim 1, wherein the at least one panel comprises a first panel having a contour and a second panel having a contour, the second panel contour different from the first panel contour, the plurality of integrated blocks comprising:
a plurality of first integrated blocks wherein the abutment surface is operable to contact the first panel when the holding element engages the first panel and the holding element is in the second position; and
a plurality of second integrated blocks wherein the abutment surface is operable to contact the second panel when the holding element engages the second panel and the holding element is in the second position.

3. The end effector of claim 2 wherein the first and the second panels are glass panels.

4. The end effector of claim 3 wherein each respective holding element of the plurality of integrated blocks comprises a pneumatic suction cup, the end effector further comprising:
a vacuum air pressure source in selective communication with the respective holding element actuator, on selective exposure of the vacuum air pressure source to the suction cup, the suction cup moves from the first position to the second position.

5. The end effector of claim 2, further comprising an integrated block position actuator connected to the base plate and to one of the first or the second integrated blocks, the integrated block actuator operable to selectively move the connected integrated block from an active position to an inactive position to provide clearance to the other of the first or the second integrated blocks not connected to the integrated block actuator for engagement of the first panel or the second panel.

6. The end effector of claim 1, wherein the at least one panel comprises a first panel having a contour and a second panel having a contour, the second panel contour different from the first panel contour, the plurality of integrated blocks comprising:
at least one of a first integrated block wherein the locating element abutment surface is operable to contact the first panel when the holding element is engaged with the first panel and is in the second position or a second integrated block wherein the abutment surface is operable to contact the second panel when the holding element is engaged with the second panel and is in the second position; and
at least one of a combination integrated block wherein the locating element abutment surface includes a first abutment surface and a second abutment surface configured differently than the first abutment surface, wherein the second integrated block first abutment surface is operable to contact the first panel when the holding element engages the first panel and the holding element is in the second position and the second integrated block second abutment surface is operable to contact the second panel when the holding element engages the second panel and the holding element is in the second position.

7. The end effector of claim 6 wherein the first and the second panels are glass panels.

8. The end effector of claim 7 wherein each holding element of the plurality of integrated blocks comprises a pneumatic suction cup, the end effector further comprising:
a vacuum air pressure source in selective communication with the respective holding element actuator, on selective exposure of the vacuum air pressure source to the suction cup, the suction cup moves from the first position to the second position.

9. The end effector of claim 8 further comprising a control system in communication with the holding element actuator operable to manipulate the holding element actuator to place the vacuum air pressure source in communication with selective of the holding element suction cups to be engaged with the first panel or the second panel.

10. The end effector of claim 7 further comprising a sensor connected to the base plate operable to detect at least one predetermined metric of the first and the second glass panels.

11. The end effector of claim 10 wherein the at least one predetermined metric comprises at least one of a glass type, a glass perimeter edge, or glass geometry.

12. The end effector of claim 6 wherein the at least one first integrated block or the second integrated block comprises a first integrated block and a second integrated block.

13. The end effector of claim 1 wherein the locating element abutment surface is a NC surface having a contour corresponding to the at least one panel contour.

14. An adaptable glass decking end effector for use with a programmable robot for selectively engaging and disengaging alternately configured glass panels, the end effector comprising:
a base plate having an upper surface, a lower surface and a perimeter;
a plurality of integrated blocks connected to the base plate and operable to selectively and alternately engage and disengage a first glass panel having a contour and a second glass panel having a contour different than the first glass panel contour, each of the plurality of integrated blocks further comprising:
a locating element connected to the base plate, the locating element including an abutment surface operable to abuttingly receive an engaged respective first glass panel or second glass panel;
a pneumatic suction cup holding element engaged with the locating element and movable between a first position and a second position relative to the locating element, a portion of the suction cup positioned between the locating element abutment surface and the glass panel when the suction cup is positioned in the second position;
the plurality of integrated blocks further comprising:
at least one of a first integrated block wherein the abutment surface is operable to contact the first glass panel when the suction cup is engaged with the first glass panel and the suction cup is in the second position or a second integrated block wherein the abutment surface is operable to contact the second glass panel when the suction cup is engaged with the second glass panel and is in the second position; and
at least one of a combination integrated block wherein the abutment surface includes a first abutment surface and a second abutment surface configured differently than the first abutment surface, wherein the second integrated block first abutment surface is operable to abuttingly receive the first glass panel when the suction cup is engaged with the first glass panel and the suction cup is in the second position and the second integrated block second abutment surface is operable to abuttingly receive the second glass panel when the suction cup is engaged with the second glass panel and the suction cup is in the second position;
a suction cup actuator in communication with the suction cups operable to selectively move the respective suction cups between the first and second position;
a vacuum air pressure source in selective communication with the respective suction cup actuator, on selective exposure of the vacuum air pressure source to the suction cup, the suction cup moves from the first position to the second position; and
a sensor connected to the base plate operable to detect at least one predetermined metric of the first and the second glass panels.

15. A panel decking system for use in installing panels on a partially assembled product traveling along an assembly line, the system comprising:
at least one first decking station positioned on opposing sides of a product path of travel, each of the at least one first decking stations further comprising:
a programmable multi-axis robot in communication with the product path of travel, the robot including an adaptable end effector operable to selectively engage and disengage at least one of a first panel or a second panel, the second panel having a different configuration than the first panel;
a panel transition area in communication with the robot operable to sequentially receive and position at least one of the first or second panels for engagement by the robot;
a vision system in communication with the panel entry point operable to detect at least one predetermined metric of the first and second panels; and
a control system in communication with the robot and the vision system operable to coordinate at least one of the at least one detected metric of the first and second panels, operation of the adaptable end effector to selectively engage the at least one first or second panels, or movement of the robot relative to the vehicle path of travel, wherein the robot is operable to selectively engage a predetermined one of the first or second panels and install the engaged panel in a selected one of a plurality of predetermined positions on the product.

16. The system of claim 15 wherein the product comprises a partially assembled passenger vehicle and the at least one of the first and second panels are glass panels.

17. The system of claim 16 wherein the robot adaptable end effector further comprises:
a base plate;
a plurality of integrated blocks connected to the base plate and operable to selectively engage and disengage one of the first or second glass panels, each of the plurality of integrated blocks further comprising:
a locating element connected to the base plate, the locating element including an abutment surface operable to abuttingly receive an engaged first or second glass panel;
a suction cup holding element engaged with the locating element and movable between a first position and a second position relative to the locating element, the suction cup operable to engage the first or the second glass panel in the first position; and
a holding element actuator in communication with the plurality of integrated block suction cups operable to selectively move the respective suction cups between the first and second position and selectively engage and disengage the at least one of the first or the second panel.

18. The system of claim 16 wherein the panel transition area further comprises:
a conveyor;
a glass panel entry end operable to sequentially receive the first and second glass panels;
a panel exit end distant from the panel entry end, the panel exit end operable to position the first or the second glass panel for engagement by the robot for installation on the product, the conveyor operable to sequentially move the first or second glass panel positioned in the entry end to the exit end.

19. The system of claim 16 further comprising a monitoring area in communication with the panel transition area, the monitoring area comprising a sensor operable to detect at least one predetermined metric of the first and the second glass panels.

20. The system of claim 15 wherein the at least one first decking station on opposing sides of the product path of travel comprises a first decking station and a second decking station positioned on opposing sides of the product path of travel.
